(19) United States
(12) Patent Application Publication
(10) Pub. No.: US 2026/0014626 A1
(43) Pub. Date: Jan. 15, 2026

(54) BUILD METHOD AND BUILD SYSTEM

(71) Applicant: NIKON CORPORATION, Tokyo (JP)

(72) Inventor: Yuichi SHIBAZAKI, Kumagaya-shi (JP)

(73) Assignee: NIKON CORPORATION, Tokyo (JP)

(21) Appl. No.: 18/837,610

(22) PCT Filed: Feb. 17, 2022
(86) PCT No.: PCT/JP2022/006327

§ 371 Date: Mar. 26, 2025

(51) Int. Cl. B22F 10/66; B22F 10/36; B22F 10/85; B33Y 10/00; B33Y 40/20; B33Y 50/02; B33Y 80/00

(52) U.S. Cl. CPC B22F 10/66; B22F 10/36; B22F 10/85; B33Y 10/00; B33Y 40/20; B33Y 50/02; B33Y 80/00

(57) ABSTRACT

A build method for forming a three-dimensional build object includes: building the build object by additive manufacturing, disposing a flow passage forming part such that the flow passage forming part faces at least a part of a polishing target surface of the build object, by passing polishing fluid through a flow passage between the build object and the flow passage forming part, performing fluid polishing a portion, which contacts the flow passage, of the build object; and disassembling of removing the flow passage forming part. It is possible to efficiently smooth surface roughness of a build object built by additive manufacturing (AM) method in which a 3D printer is used, for example.

### TECHNICAL FIELD

The present invention relates to a build method and a build system for forming a three-dimensional build object.

### BACKGROUND ART

It is known that a build apparatus forming a build object by re-solidifying melted material after powdered materials melted by an energy beam, as an apparatus forming a build object with additive manufacturing method such as a 3D printer (see a patent literature 1). In this build apparatus, since a surface of a built object is relatively rough, it is required to be able to efficiently smooth surface roughness after building.

### CITATION LIST

### Patent Literature

Patent Literature 1: US 2017/0014909 A1

### SUMMARY OF INVENTION

A first aspect provides a build method for forming a three-dimensional build object, including: building the build object by additive manufacturing (AM); disposing a flow passage forming part such that the flow passage forming part faces at least a part of the build object; by passing polishing fluid through a flow passage between the build object and the flow passage forming part, performing fluid polishing a portion, which contacts the flow passage, of the build object; and disassembling the flow passage forming part.

A second aspect provides a build system for forming a three-dimensional build object provided with: a build apparatus building the build object and a flow passage forming part, which is disposed such that the flow passage form part faces at least a part of the build object, by additive manufacturing; and a fluid polishing apparatus performing a portion, which contacts a flow passage between the build object and the flow passage forming part, of the build object by passing polishing fluid through the flow passage.

### BRIEF DESCRIPTION OF DRAWINGS

FIG. 1 is a perspective view that illustrates a build system of a first embodiment.

FIG. 2 is a cross-sectional view that illustrates a build apparatus 4 in FIG. 1.

Each of FIG. 3A, FIG. 3B and FIG. 3C is a cross-sectional view that illustrates an aspect in which a certain area on a workpiece is irradiated with light and build materials are supplied thereto.

Each of FIG. 4A and FIG. 4B is a plane view that illustrates moving trajectory of an irradiation area on a build surface.

Each of FIG. 5A, FIG. 5B and FIG. 5C is a cross-sectional view that illustrates a process for forming a three-dimensional structural object.

FIG. 6A is a perspective view that illustrates an example of a build target; FIG. 6B is a perspective view that illustrates a polishing target in which a flow passage covering part is provided with the build target; FIG. 6C is a plane view of FIG. 6B; FIG. 6D is a perspective view that illustrates an aspect after removing the flow passage covering part from the build target; FIG. 6E is an enlarged view that illustrates a connection part of a modified example; FIG. 6F is an enlarged cross-sectional view that illustrates a flow passage covering part of the modified example.

FIG. 7A is a cross-sectional view that illustrates a polishing target disposed on a fluid polishing apparatus; FIG. 7B is a bottom view of a supply jig in FIG. 7A.

FIG. 8A is a cross-sectional view that illustrates a case in which the fluid polishing apparatus polishes an inner surface of the polishing target; FIG. 8B is a cross-sectional view that illustrates a polishing target disposed on a fluid polishing apparatus of a modified example.

FIG. 9A is a flowchart that illustrates one example of a build method; FIG. 9B is a flowchart that illustrates one example of a build method for a build target and a flow passage covering part; FIG. 9C is a flowchart that illustrates one example of fluid polishing for the polishing target.

FIG. 10A is a perspective view that illustrates a flow passage covering part of a modified example; FIG. 10B is a perspective view that illustrates a flow passage covering part of an other modified example.

FIG. 11A is a cross-sectional view that illustrates a build target of a modified example; FIG. 11B is a cross-sectional view that illustrates a polishing target of the modified example.

FIG. 12A is a perspective view that illustrates a pipe of a build target of an other modified example; FIG. 12B is a perspective view that illustrates the pipe and a flow passage covering part of the other modified example; FIG. 12C is an explanation drawing that illustrates fluid polishing of the other modified example; FIG. 12D is a perspective view that illustrates the pipe of the other modified example after fluid polishing; FIG. 12E is a perspective view that illustrates a build target and a flow passage covering part of a further modified example.

FIG. 13 is a perspective view that illustrates a build system of a second embodiment.

### DESCRIPTION OF EMBODIMENTS

### First Embodiment

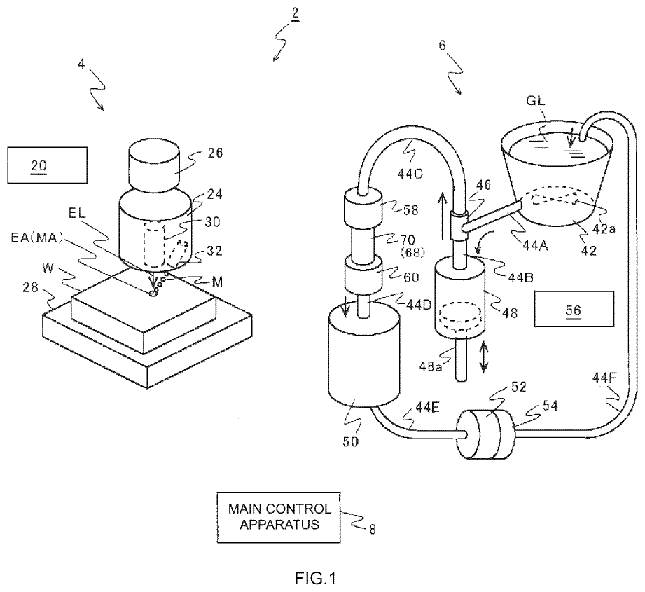

Hereinafter, a first embodiment will be described with reference to FIG. 1 to FIG. 9C.

In this embodiment, first, a three-dimensional build object is built (manufactured) with additive manufacturing (AM) method in which materials, such as metal or synthetic resin, are successively added like a 3D printer. Hereinafter, the additive manufacturing is also referred to as AM method. The AM method includes Directed Energy Deposition (DED), Powder Bed Fusion (PBF), Binder Jetting (BJT), and so on. Any method can be applied to the AM method of this embodiment. As described later, the AM method of this embodiment uses additive layer manufacturing, but the additive layer manufacturing may be not always used. In the following description, it is supposed that Laser Melt Deposition (LMD) using light such as laser as an energy beam is used (hereinafter, it also referred to as LMD method), from the Directed Energy Deposition (DED), as one example of the AM method.

A build object built by the AM method such as a 3D printer tends to have relatively large surfaces roughness. Therefore, the surface roughness of the build object is sometimes smoothed by post-processing or mechanical polishing after building. However, a shape of a surface of the build object is complex or if mechanical polishing or the like can not be performed efficiently, it is difficult to efficiently smooth the surface roughness. In this embodiment, when a build object is built by the AM method, a flow passage covering part (or, also referred to as a flow passage forming part) is built in advance so that the flow passage covering part covers a part, surface roughness of which is to be smoothed, of the build object. Furthermore, a polishing liquid is flowed into the flow passage between the surface of the build object and the flow passage covering part, thereby the polishing liquid smooths a surface, which contacts the flow passage, of the build object. Smoothing a surface by flowing a polishing liquid on the surface of an object in this way is referred to as fluid polishing below. Then, in order to disassemble the flow passage covering part from the build object, the flow passage covering part removed by such as crushing or breaking, thereby the build object, surface roughness of which is smooth, is obtained.

FIG. 1 shows a build system 2 of this embodiment. In FIG. 1, the build system 2 is provided with a build apparatus 4 which consists of a 3D printer using, for example, the LMD method, a fluid polishing apparatus 6 performing fluid polishing a polishing target (i.e., a build target), a main control apparatus 8 which consists of a computer controlling operation of the whole system, and a carrier system not illustrated.

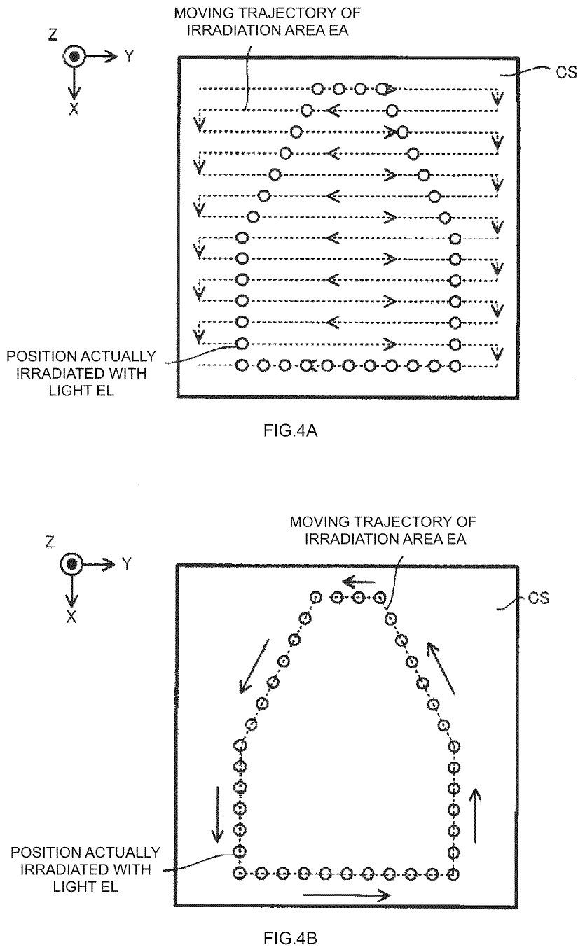

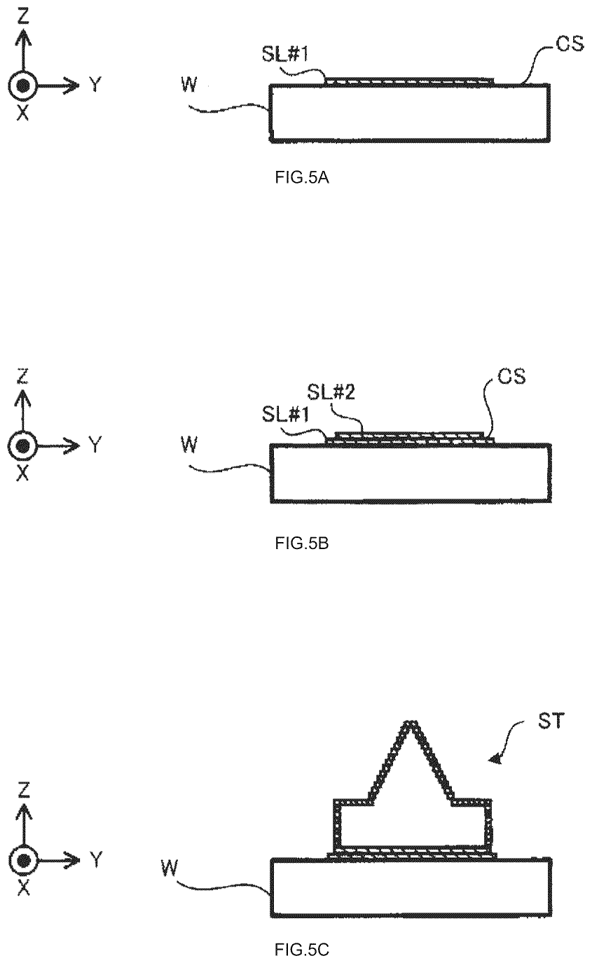

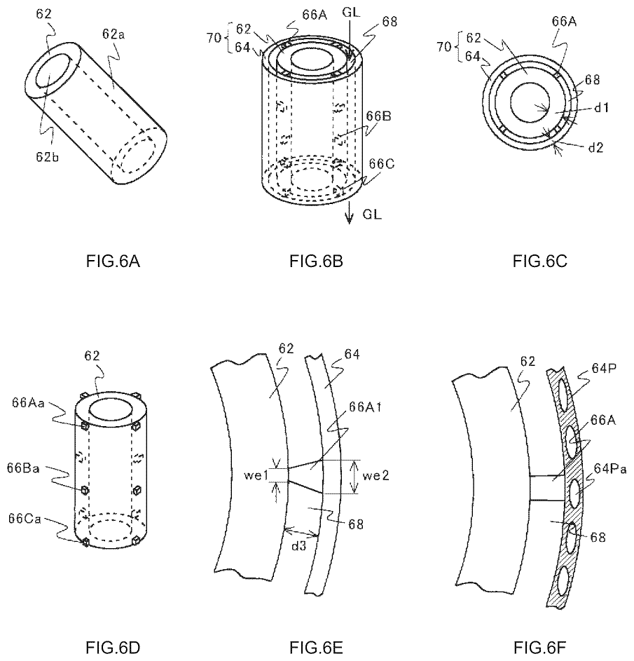

The build apparatus 4 is provided with a stage 28 on which a workpiece W, which becomes a base (i.e., a base material) for forming a three-dimensional structural object, is placed, an irradiation optical system 30 irradiating light EL to the workpiece W, a build head 24 which has a material nozzle 32 supplying a build material M to the workpiece W, a driving system 26 moving the build head 24, and a control apparatus 20. As one example, a three-dimensional model data of a build target is outputted from the main control apparatus 8 to the control apparatus 20. The control apparatus 20 creates a three-dimensional model data of a flow passage covering part by using the three-dimensional model data. Then, under control of the control apparatus 20, a polishing targe 70 (see FIG. 6B) has a shape combining the build target and the flow passage covering part is built on a workpiece W with the AM method by controlling supplying a build material M to a supply area MA of the workpiece W, irradiating light EL to an irradiation area EA, which partially overlaps with the supply area MA, and moving the build head 24 by the driving system 26. Detail configuration and operation of the build apparatus 4 will be described later. The built polishing target 70 is carried to the fluid polishing apparatus 6 through the carrier system not illustrated (such as a robot hand).

The fluid polishing apparatus 6 is provided with a supply tank 42 housing a polishing liquid GL, a cylinder 48 temporarily storing the polishing liquid GL, a collection tank 50 collecting the polishing liquid GL which has been used to fluid polishing, and a control apparatus 56. A stirring part 42a, which rotates for stirring the polishing liquid GL, is provided in the supply tank 42. The supply tank 42 is also provided with a temperature controlling part (not illustrated), which controls temperature of the inner polishing liquid GL to a predetermined temperature. A bottom of the supply tank 42 and the cylinder 48 are connected through piping 44A, a three-way valve 46 and piping 44B. The cylinder 48 is provided with a piston 48a. It is possible to switch storing the polishing liquid GL to the cylinder and discharging the polishing liquid GL from the cylinder 48 with a set flow rate per unit time by pulling the piston 48a from the cylinder 48 and push the piston 48a into the cylinder 48 by a motor not illustrated.

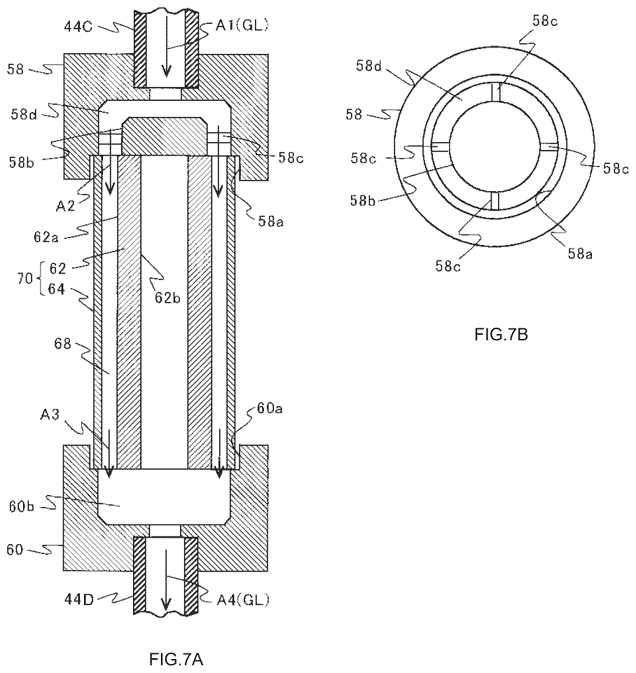

Moreover, a flow passage 68 (see FIG. 7A) is formed in the polishing target 70 (detail will be described later), and, a supply jig 58 and a discharge jig 60 are disposed at a terminal of the flow passage 68, at which the polishing liquid GL is supplied, and a terminal of the flow passage 68, at which the polishing liquid GL is discharged, respectively. The supply jig 58 is connected to the three-way valve 46 through piping 44C, the discharge jig 60 is connected to the collection tank 50 through piping 44D. The supply jig 58, the polishing target 70 and the discharge jig 60 are held by a holding member not illustrated. Wherein, the supply jig 58 and the discharge jig 60 are not always needed. Moreover, when only the supply jig 58 is provided, the polishing liquid GL, which has passed through the polishing target 70, may be directly collected into the collection tank 50. Moreover, a bottom of the collection tank 50 is connected to a top of the supply tank 42 through piping 44E, a pump 52, a filter 54 and piping 44F. A valve, which performs opens and closes of an opening (not illustrated) leading the piping 44E, is provided at the bottom of the collection tank 50. The filter 54 removes particles such as metal generated by polishing from the polishing liquid GL, which has flowed a flow passage of the polishing target 70. Wherein, the configuration of the fluid polishing apparatus 6 is not limited to the configuration illustrated in FIG. 1, and can adopt any configuration.

In this embodiment, the polishing liquid GL is a mixture of an abrasive grain and a liquid medium (i.e., a mixture of a particulate solid and a liquid). The polishing liquid GL may be also referred to slurry. As one example, since abrasive grain is heavier than a liquid medium, dispersing agent is mixed into the polishing liquid GL in order to prevent the abrasive grain precipitating. Moreover, the stirring part 42a is provided in the supply tank 42 in order to prevent the abrasive grain precipitating.

A powder of a material, which is selected from an abrasive grain group including such as diamond, cerium oxide, cubic boron nitride (CBN), polycrystalline boron nitride (PCBN), silicon carbide, tungsten carbide, boron carbide, alumina (aluminum oxide Al₂O₃), or silicon dioxide, can be used as the abrasive grain. The abrasive grain is selected on the basis of such as a material, a shape of a flow passage and required surface roughness of the polishing target 70. Grain size of the abrasive grain is set on the basis of such as the material, the shape of flow passage and the required surface roughness of the polishing target 70. As one example, volume concentration of the abrasive grain to the polishing liquid GL is about 3-30%. Wherein, powders of a plurality of materials selected from the abrasive grain group can be used as the abrasive grain.

Moreover, a low viscosity liquid can be used as the liquid medium. Such as water (including such as ion exchanged water), silicon oil, alcohol, organic solvent or oil (such as vegetable oil, mineral oil, distillate, synthetic oil) can be used as the liquid medium. The liquid medium is selected on the basis of such as miscibility (such as an abrasive grain does not precipitate easily), and required surface roughness of the polishing target 70. Wherein, as required, a middle viscosity or high viscosity liquid, which is not the low viscosity liquid, can be used as the liquid medium.

Furthermore, a magnetic fluid liquid using magnetic fluid (e.g., fluid, in which magnetite is mixed into water) as the liquid medium and alumina, which is a non-magnetic material, as the abrasive grain can be used as the polishing liquid GL. Such magnetic fluid liquid may be used according to such as material of the polishing material 70.

The control apparatus 56 of the fluid polishing apparatus 6 controls operations of the three-way valve 46, the cylinder 48 and the pump 52. Moreover, a status sensor (not illustrated), which detects pressure, flow velocity and flow rate per unit time of the polishing liquid GL, is provided in the piping 44C, for example. The control apparatus 6 controls flow rate per unit time of the polishing liquid GL discharged from the cylinder 48, and so on according to a detection result of the status sensor. Moreover, the control apparatus 56 performs fluid polishing to the polishing target 70 by using polishing information (such as flow rate per unit time of the polishing liquid GL and duration time of polishing) of the polishing target 70 outputted from the main control apparatus 8.

In the fluid polishing apparatus 6, when the polishing liquid GL is stored in the cylinder 48, the three-way valve is set such that the piping 44A and the piping 44B are communicated with each other, and the piston 48a is pulled down. By these operations, at least a part of polishing liquid GL in the supply tank 42 is stored into the cylinder 48 through the piping 44A, the tree-way valve 46 and the piping 44B. After that, when fluid polishing to the polishing target 70 is performed, the tree-way valve is set such that the piping 44B and the piping 44C are communicated with each other, and the piston 48a is pushed up with a predetermined velocity. By these operations, the polishing liquid GL in the cylinder 48 is supplied (or pumped) into the flow passage 68 in the polishing target 70 with a set flow rate per unit time through the piping 44B, the tree-way valve 46, the piping 44C and the supply jig 58. The polishing liquid GL, which has flowed through the flow passage 68 in the polishing target 70, is collected into the collection tank 50 through the piping 44D. Storing the polishing liquid GL into the cylinder 48 and discharging (pumping) the polishing liquid GL from the cylinder 48 are repeated, for example, a number of times set according to such as required surface roughness of the polishing target 70 (a number of times corresponding to disrupt time of polishing), thereby a portion, which contacts the flow passage 68, of the polishing target 70 is smoothly fluid polished.

Moreover, for example, storing the polishing liquid GL into the cylinder 48 and discharging the polishing liquid GL from the cylinder 48 are repeated a predetermined number of times, after then, the polishing liquid GL is returned to the supply tank 42 through the piping 44E, the pump 52, the filter 54 and the piping 44F by opening a valve in the collection tank 50 which leads to the piping 44E, and operating the pump 52. By repeating these operations, fluid polishing to the polishing target 70 and other polishing targets is sequentially performed.

Moreover, in the fluid polishing apparatus 6, since supplying the polishing liquid GL is performed by using the cylinder 48 intermittently, an apparatus configuration becomes simple. As another configuration, for example, a feed pump is mounted on the way of the piping 44A leading to the supply tank 42, and it may be configured such that the feed pump can directly continuously supply the polishing liquid GL to a flow passage of the polishing target 70. Wherein, more detail configuration and operation of the fluid polishing apparatus 6 is disclosed in US 2007/0049178 A1. Furthermore, a fluid polishing apparatus described in JP 6869516 B may be used as the fluid polishing apparatus 6.

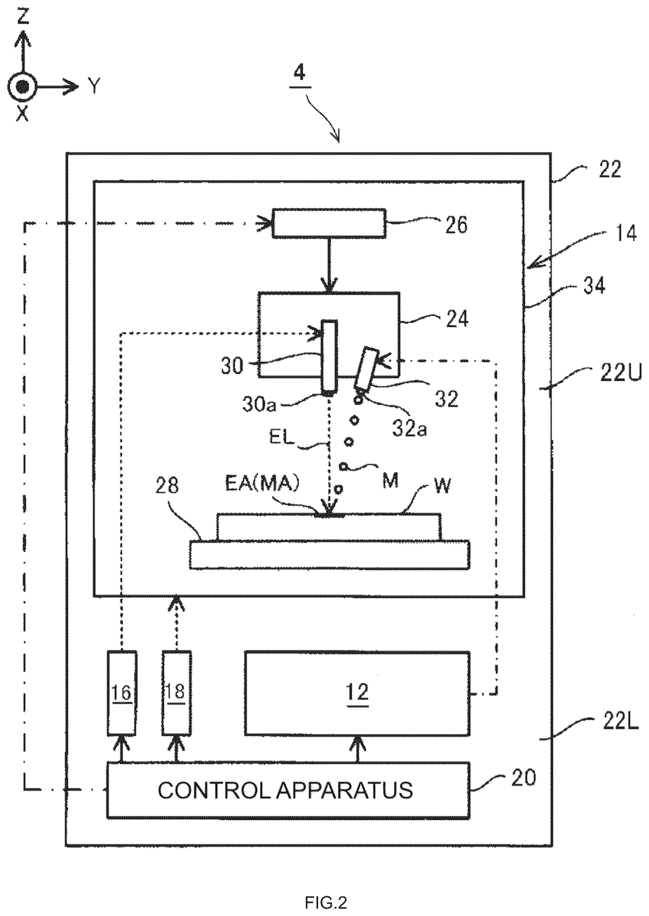

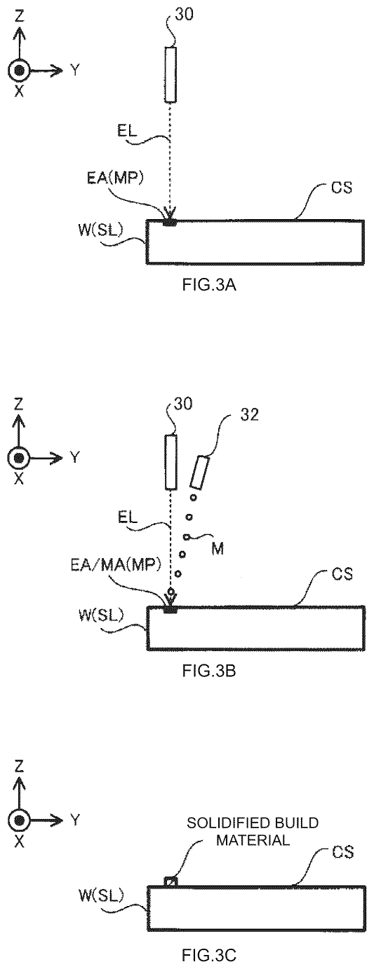

Next, detail configuration and operation of the build apparatus 4 illustrated in FIG. 1 are described. FIG. 2 illustrates the build apparatus 4. The build apparatus 4 is a 3D printer using the LMD method. The LMD method may be referred to as a Direct Metal Deposition, a Direct Energy Deposition, a Laser Cladding, a Laser Powder Deposition, a Laser Active Manufacturing or a Laser Rapid Forming, etc. Moreover, in FIG. 2, a positional relationship of various components that constitute the build apparatus 4 will be described by using an XYZ rectangular coordinate system that is defined by an X axis, a Y axis and a Z axis that are perpendicular to one another. Hereinafter, it is assumed that a surface formed by the X axis and the Y axis is a horizontal plane, and the Z axis is perpendicular to the horizontal plane. In this case, a direction (Z direction), which is parallel to the Z axis, is assumed to be parallel to a vertical direction, and −Z direction is assumed to be the vertical direction.

The build apparatus 4 can form a three-dimensional structural object ST (see FIG. 5C) (namely, an object having a size in each of three-dimensional directions). The build apparatus 4 can form the three-dimensional structural object ST on a workpiece W with the AM method. When the workpiece W is the stage 28, the build apparatus 4 can form the three-dimensional structural object ST on the stage 28. When the workpiece W is an existing structural object held by the stage 28, the build apparatus 4 can form the three-dimensional structural object ST by adding a new structural object on the existing structural object. In this case, the build apparatus 4 may form the three-dimensional structural object ST that integrated with the existing structural object. Alternatively, the build apparatus 4 may form the three-dimensional structural object ST that is separable from the existing structural object. Hereinafter, as illustrated in FIG. 2, it will be described that the workpiece W is assumed to be an existing structural object held by the stage 28.

In order to form the three-dimensional structural object ST, the build apparatus 4 is provided with a material supply apparatus 12, a build part 14, a light source 16, a gas supply apparatus 18 and a control apparatus 20. The material supply apparatus 12, the build part 14, the light source 16, the gas supply apparatus 18 and the control apparatus 20 are housed in a housing 22. In an example illustrated in FIG. 2, the build part 14 is housed in an upper space 22U of the housing 22, and, the material supply apparatus 12, the light source 16, the gas supply apparatus 18 and the control apparatus 20 are housed in a lower space 22L of the housing 22. However, an arranged position in the housing 22 of each of the material supply apparatus 12 to the control apparatus 20 is not limited to an arranged position illustrated in FIG. 2. Moreover, the control apparatus 20 may be displaced at a position far from the housing 22.

The material supply apparatus 12 supplies build materials M to the build part 14. Such that an amount of build materials M required per unit time for the build part 14 forming the three-dimensional structural object ST is supplied to the build part 14, the material supply apparatus 12 supplies an amount of the build materials M according to the required amount.

The build material M is a material that is molten by an irradiation of a light EL having a predetermined intensity or more intensity. For example, at least one of a metal material and a resin material is usable as the build material M. However, another material that is different from the metal material and the resin material may be used as the build material M. The build materials M are powder-like or grain-like materials (powder particle). However, the build materials M may not be the powdery or granular materials, and a wire-like build materials or a gas-like material may be used, for example.

The build part 14 forms the three-dimensional structural object ST by processing the build materials M supplied from the material supply apparatus 12. In order to process the build materials M, the build part 14 is provided with the build head 24, the driving system 26 and the stage 28. Furthermore, the build head 24 is provided with the irradiation optical system 30 and the material nozzle 32 (namely, a supply system that supplies the build materials M). The build head 24, the driving system 26 and the stage 28 are housed in a chamber 34.

The irradiation optical system 30 is an optical system (for example, a condensing optical system) for emitting the light EL from an emitting part 30a. Specifically, the irradiation optical system 30 is optically connected to the light source 16 that generates the light EL through a non-illustrated light transmitting member such as an optical fiber and light guide. The irradiation optical system 30 emits the light EL transmitted from the light source 16 through the light transmitting member in a downward direction (namely, −Z direction). When the workpiece W is loaded on the stage 28, the irradiation optical system 30 emits the light EL toward the workpiece W on the stage 28. The irradiation optical system 30 can emit the light EL to an irradiation area EA that is set on the workpiece W as an area that is irradiated with the light EL (typically, in which the light is condensed). Furthermore, a state of the irradiation optical system 30 is switchable between a state where the irradiation area EA is irradiated with the light EL and a state where the irradiation area EA is not irradiated with the light EL under the control of the control apparatus 20. Wherein, a direction of the light EL emitted from the irradiation optical system 30 is not limited to a direct downward direction (namely, the −Z direction), and may be a direction that is inclined with respect to the Z axis by a predetermined angle, for example.

The material nozzle 32 has a supply outlet 32a that supplies the build materials M. The material nozzle 32 supplies (specifically, injects, blows out or sprays) the build materials M from the supply outlet 32a. The material nozzle 32 is physically connected to the material supply apparatus 12 that is a supply source of the build materials M through a non-illustrated pipe and the like. The material nozzle 32 may pressure-feed the build materials M supplied from the material supply apparatus 12 through the pipe. Namely, the build materials M from the material supply apparatus 12 and gas (for example, inert gas such as Nitrogen or Argon) for feeding are mixed and pressure-fed to the material nozzle 32 through the pipe. Wherein, although the material nozzle 32 is illustrated to have a tube-like shape in FIG. 1, the shape of the material nozzle 32 is not limited to this shape.

The material nozzle 32 supplies the build materials M in a downward direction (namely, the −Z direction side) from the material nozzle 32. When the workpiece W is loaded on the stage 28, the material nozzle 32 supplies the build materials M toward the workpiece W. As one example, although a moving direction of the build materials M supplied from the material nozzle 32 is inclined with respect to the Z axis by a predetermined angle (as one example, an acute angle), it may be the −Z direction side (namely, a direct downward direction).

In this embodiment, the material nozzle 32 supplied the build materials M toward the irradiation area EA that is irradiated with the light EL by the irradiation optical system 30. In other words, the material nozzle 32 is aligned to the irradiation optical system 30 such that the irradiation area EA is coincident with (alternatively, at least partially overlaps with) a supply area MA on the workpiece W where the material nozzle 32 supplies the build materials M. Wherein, the material nozzle 32 may aligned so as to supply the build materials M to a melt pool MP (see FIG. 3A) that is formed at the workpiece W by the light EL emitted from the irradiation optical system 30.

The driving system 26, which includes such as a motor and an encoder for detecting a position, moves the build head 24 along at least any of the X axis, the Y axis and the Z axis. When the build head 24 moves along at least one of the X axis and the Y axis, the irradiation area EA moves on the workpiece W along at least one of the X axis and the Y axis. Furthermore, the driving system 26 may move the build head 24 along at least one of directions inclining by angle 6X, 6Y and 6Z around axes that are parallel to the X axis, the Y axis and the Z axis, respectively, in addition to or instead of at least one of the X axis, the Y axis and the Z axis. Wherein, the driving system 26 may move the irradiation optical system 30 and the material nozzle 32 separately. Specifically, for example, the driving system 26 may adjust at least one of a position of the emitting part 30a, a direction of the emitting part 30a, a position of the supply outlet 32a and a direction of the supply outlet 32a. In this case, the irradiation area EA that is irradiated with the light EL by the irradiation optical system 30 and the supply area MA to which the material nozzle 32 supplies the build materials M are controllable separately. Wherein, the driving system 26 may rotate the build head 24 along an axis (a rotation axis) inclining to an axis, that is parallel to the X axis, and an axis, that is parallel to the Y axis.

The stage 28 can hold the workpiece W through a mechanical chuck, a vacuum chuck and the like. Furthermore, the stage 28 can release the held workpiece W. In at least a part of a period when the stage 28 holds the workpiece W, the irradiation optical system 30 irradiates the light EL and the material nozzle 32 supplies the build materials M. Wherein, there is a possibility that a part of the build materials M supplied by the material nozzle 32 is scattered or drops outside of the workpiece W (for example, around the stage 28). Thus, the build apparatus 4 may be provided with a recovery apparatus that recovers the build material M scattered or dropping around the state 28.

The light source 16 emits, as the light EL, laser light having a wavelength of at least one of infrared light, visible light and ultraviolet light, for example. However, another type of light may be used as the light EL. The light source 16 may include a laser light source such as a semiconductor laser (LD: Laser Diode). The laser light source may be a fiber laser, a CO₂ laser, a YAG laser, an Excimer laser or the like. However, the light EL may not be the laser light and the light source 16 may include any light source (for example, at least one of a LED (Light Emitting Diode), a discharge lamp and the like).

The gas supply apparatus 18 is a supply source of purge gas. The purge gas includes inert gas. Nitrogen gas or Argon gas is one example of the inert gas. The gas supply apparatus 18 supplies the purge gas into the chamber 34 of the build part 14. As a result, an inner space of the chamber 34 is a space that is purged by the purge gas. Wherein, the gas supply apparatus 18 may be a tank that stores the inert gas such as Nitrogen gas or Argon gas, and may be an apparatus separating Nitrogen gas from air when the inert gas is Nitrogen gas.

The control apparatus 20 controls operations of the build apparatus 4. The control apparatus 20 includes a CPU (Central Processing Unit), a GPU (Graphics Processing Unit), a memory, a recording medium, an input/output part and the like, for example. The control apparatus 20 functions an apparatus controlling operations of the build apparatus 4 by the CPU executing a computer program. The computer program is a computer program that allows the control apparatus 20 (for example, the CPU) to execute below described operations to be performed by the build apparatus 4. The computer program executed by the CPU may be recorded in the memory (namely, a recording medium) provided in the control apparatus 20, or may be recorded in the recording medium (for example, a hard disk, a CD-ROM, a DVD-RAM or a semiconductor memory) of the control apparatus 20. Alternatively, the CPU may download the computer program that should be executed from an apparatus (for example, the main control apparatus 8) disposed outside the control apparatus 20 through a network interface. The control apparatus 20 may not be disposed in the build apparatus 4, and may be disposed outside the build apparatus 4 as a server and the like.

In this embodiment, the control apparatus 20 controls an emitting aspect of the light EL by the irradiation optical system 30. The emitting aspect includes at least one of intensity of the light EL and emitting timing of the light EL, for example. When the light EL is pulse light, the emitting aspect may include at least one of a length of luminescence time of the pulse light and a ratio (so-called a duty ratio) of luminescence time and quenching time of the pulse light. Furthermore, the control apparatus 20 controls a moving aspect of the build head 24 by the driving system 26. The moving aspect includes at least one of a moving amount, a moving speed, a moving direction and a moving timing, for example. Furthermore, the control apparatus 20 a supplying aspect of the build materials M by the material nozzle 32. The supplying aspect includes at least one of a supplied amount (especially, a supplied amount per unit time) and a supply timing.

Next, build operation (namely, operation for forming the three-dimensional structural object ST) of the build apparatus 4 will be described. As described above, the build apparatus 4 forms the three-dimensional structural object ST by the Laser Metal Deposition (the LMD method).

The build apparatus 4 forms the three-dimensional structural object ST on the workpiece W on the basis of a three-dimensional model data (for example, a CAD (Computer Aided Design) data) or the like of the three-dimensional structural object ST that should be formed. The three-dimensional data (hereinafter, also referred to as a 3D data) is supplied from the main control apparatus 8 to the control apparatus 20 of the build apparatus 4, for example. Furthermore, a measured data of a solid object measured by a measurement apparatus (not illustrated) disposed in the build apparatus 4, or a measured data by a three-dimensional shape measurement device disposed separately from the build apparatus 4 may be used as the three-dimensional model data. Wherein, a STL (Stereo Lithography) format, a VRML (Virtual Reality Modeling Language) format, an AMF (Additive Manufacturing File Format), a Bitmap format and the like may be used as the three-dimensional model data, for example. As one example, the build apparatus 4 sequentially forms a plurality of layered partial structural objects (hereinafter, also referred to as a structural layer) SL that are obtained by round slicing the three-dimensional structural object ST along the Z axis direction in order to form the three-dimensional structural object ST. As a result, the three-dimensional structural object ST that is a layered structural body in which the plurality of structural layers SL are layered is formed. Hereinafter, flow of operation for forming the three-dimensional structural object ST by forming the plurality of structural layers SL one by one in order will be described.

Firstly, operation for forming each structural layer SL will be described. The build apparatus 4 sets the irradiation area EA at a desired area on a build surface CS that corresponds to a surface of the workpiece W or a surface of the formed structural layer SL and emits the light EL from the irradiation optical system 30 to the irradiation area EA under the control of the control apparatus 20. In this embodiment, a light concentration position (namely, a condensed position) of the light EL is coincident with the build surface CS. As a result, as illustrated in FIG. 3A, a melt pool (namely, a pool of a melt molten by the light EL) MP is formed at the desired area on the build surface CS by the light EL emitted from the irradiation optical system 30. Furthermore, the build apparatus 4 sets the supply area MA at the desired area on the build surface CS and supplies the build materials M to the supply area MA from the material nozzle 32 under the control of the control apparatus 20. Here, since the irradiation area EA is coincident with the supply area MA as described above, the supply area MA is set at an area at which the melt pool MP is formed. Thus, the build apparatus 4 supplies the build materials M to the melt pool MP from the material nozzle 32, as illustrated in FIG. 3B. As a result, the build materials M supplied to the melt pool MP are molten. When the melt pool MP is not irradiated with the light EL due to the movement of the build head 24, the build materials M molten in the melt pool MP are cooled and solidified (namely, coagulated) again. As a result, as illustrated in FIG. 3C, the build materials M solidified again are deposited on the build surface CS.

A series of build process including the formation of the melt pool MP by the irradiation of the light EL, the supply of the build materials M to the melt pool MP, the melting of the supplied build materials M and the re-solidification of the molten build materials M is repeated while relatively moving the build head 24 relative to the build surface CS along the XY plane. In other words, when the build head 24 relatively moves relative to the build surface CS, the irradiation area EA also relatively moves relative to the build surface CS. Therefore, the series of build process is repeated while relatively moving the irradiation area EA relative to the build surface CS along the XY plane (namely, in a two-dimensional plane). In this case, the irradiation area EA set at the area on which the build object should be formed on the build surface CS is selectively irradiated with the light EL and the irradiation area EA set at an area on which the build object should not be formed on the build surface CS is not selectively irradiated with the light EL (it can be said that the irradiation area EA is not set at the area on which the build object should not be formed). In other words, the build apparatus 4 moves the irradiation area EA along a predetermined moving trajectory on the build surface CS and irradiates the build surface CS with the light EL at a timing based on a distribution pattern of an area on which the build object should be formed (namely, a pattern of the structural layer SL). As a result, the melt pool MP also moves on the build surface CS along a moving trajectory based on the moving trajectory of the irradiation area EA. Specifically, the melt pool MP is formed in series at a part that is irradiated with the light EL in the area along the moving trajectory of the irradiation area EA on the build surface CS.

Moreover, since the irradiation area EA is coincident with the supply area MA as described above, the supply area MA also moves on the build surface CS along a moving trajectory based on the moving trajectory of the irradiation area EA. As a result, the structural layer SL that is an aggregation of the build object of the solidified build materials M is formed on the build surface CS. In other words, the structural layer SL that is an aggregation of the build object formed in a pattern based on the moving trajectory of the melt pool MP on the build surface CS (namely, the structural layer SL having a shape based on the moving trajectory of the melt pool MP in a planar view) is formed. Incidentally, when the irradiation area EA is set at the area on which the build object should not be formed, the irradiation area EA may be irradiated with the light EL and the supply of the build materials M may be stopped. Moreover, when the irradiation area EA is set at the area on which the build object should not be formed, the build materials M may be supplied to the irradiation area EL and the irradiation area EA may be irradiated with the light EL having an intensity by which the melt pool MP is not formed.

The irradiation area EA may move along a first moving trajectory in which the movement of the irradiation area EA along the Y axis direction and the movement of the irradiation area EA along the X axis direction are repeated as illustrated in FIG. 4A in a layer forming period in which one structural layer SL is formed on the build surface CS. In an example illustrated in FIG. 4A, the irradiation area EA moves along a moving trajectory in which the movement of the irradiation area EA toward +Y side, the movement of the irradiation area EA toward +X side, the movement of the irradiation area EA toward −Y side and the movement of the irradiation area EA toward +X side are repeated. In this case, the build apparatus 4 emits the light EL at a timing when the irradiation area EA is set at the area on which the build object should be formed on the build surface CS. Especially, in the example illustrated in FIG. 4A, a moving distance of the irradiation area EA along the Y axis direction (especially, a moving distance by one-time movement before a moving direction of the irradiation area EA is switched to the X axis direction) is larger than a moving distance of the irradiation area EA along the X axis direction. In this case, the build apparatus 4 emits the light EL in a period when the irradiation area EA moves along the Y axis (alternatively, either one of the X axis and Y axis along which the moving distance of the irradiation area EA by the one-time movement is larger than the other one) and does not emit the light EL in a period when the irradiation area EA moves along the X axis (alternatively, either one of the X axis and Y axis along which the moving distance of the irradiation area EA by the one-time movement is smaller than the other one). Incidentally, it can be said that the moving trajectory illustrated in FIG. 4A is a moving trajectory corresponding to a scan by what we call a raster scan. In this case, the moving trajectory of the irradiation area EA rarely intersects with itself, although the moving trajectory of the irradiation area EA does not always have no chance of intersecting.

Alternatively, the irradiation area EA may move along a second moving trajectory that is along the pattern of the structural layer SL as illustrated in FIG. 4B in the layer forming period. Even in this case, the build apparatus 4 emits the light EL at the timing when the irradiation area EA is set at the area on which the build object should be formed on the build surface CS. However, since the irradiation area EA moves along the second moving trajectory that is along the pattern of the structural layer SL, it can be said that the irradiation area EA basically overlaps with the area on which the build object should be formed on the build surface CS. Therefore, the build apparatus 4 may keep emitting the light EL during a period when the irradiation area EA moves. In this case, the melt pool MP also moves along the second moving trajectory that is along the pattern of the structural layer SL. As a result, the build process that extends the build object along a direction along which the irradiation area EA moves relative to the structural layer SL. Incidentally, it can be said that the moving trajectory illustrated in FIG. 4B is a moving trajectory corresponding to a scan by what we call a vector scan. In this case, the control apparatus 20 may set the moving trajectory of the irradiation area EA so that the moving trajectory of the irradiation area EA does not intersects with itself on the build surface CS (especially, the moving trajectory of the melt pool MP does not intersects with itself on the build surface CS). Wherein, although the irradiation area EA is moved relative to the build surface CS by moving the build head 24 (namely, the light EL) relative to the build surface CS in the above described description, the build surface CS may be moved and both of the build head 24 (namely, the light EL) and the build surface CS may be moved.

The build apparatus 4 repeats the operation for forming the structural layer SL on the basis of the three-dimensional model data under the control of the control apparatus 20. Specifically, a slice data is firstly generated by performing a slicing process on the three-dimensional model data by a layer pitch. Wherein, a data obtained by partially modifying the slice data on the basis of a characteristic of the build apparatus 4 may be used. The build apparatus 4 performs an operation for forming the first structural layer SL #1 on the build surface CS that corresponds to the surface of the workpiece W on the basis of the three-dimensional model data corresponding to a structural layer SL #1, namely, the slice data corresponding to the structural layer SL #1. As a result, as illustrated in FIG. 5A, the structural layer SL #1 is formed on the build surface CS. Then, the build apparatus 4 sets the surface of the structural layer SL #1 to a new build surface CS and forms a second structural layer SL #2 on the new build surface CS. In order to form the structural layer SL #2, firstly, the control apparatus 20 controls the driving system 26 so that the build head 24 moves along the Z axis direction. Specifically, the control apparatus 20 controls the driving system 26 to move the build head 24 toward the +Z axis side so that the irradiation area EA and the supply area MA are set on the surface of the structural layer SL #1 (namely, the new build surface CS). By this, the light concentration position of the light EL is coincident with the new build surface CS. Then, the build apparatus 4 forms the structural layer SL #2 on the structural layer SL #1 on the basis of the slice data corresponding to the structural layer SL #2 by the operation that is the same as the operation for forming the structural layer SL #1 under the control of the control apparatus 20. As a result, as illustrated in FIG. 5B, the structural layer SL #2 is formed. Then, the same operation is repeated until all structural layers SL constituting the three-dimensional structural object ST that should be formed on the workpiece W are formed. As a result, the three-dimensional structural object ST is formed by a layered structural object in which the plurality of structural layers SL are layered along the Z axis, as illustrated in FIG. 5C.

Incidentally, more detail configuration and operation of the build apparatus 4 is disclosed in US 2021/0220948 A1, for example.

Next, in this embodiment, as illustrated in FIG. 6A, operation will be described when a cylindrical metal pipe 62, as one example of the build target, is built. When the pipe 62 is built, since an inner surface 62b of the pipe is innately a flow passage for liquid flowing and polishing liquid easily flows on the inner surface 62b, it is possible to fluid polish the inner surface 62b in this state. On the other hand, when there is no cover or the like for an outer surface 62a of the pipe 62, it is difficult to pour polishing liquid over the entire outer surface 62a uniformly. Furthermore, it is difficult to mechanically polish the entire outer surface 62a of the pipe 62 in a short time.

Therefore, in this embodiment, in order to perform fluid polishing the outer surface 62a of the pipe 62, when the build apparatus 4 builds the pipe 62, as illustrated in FIG. 6B, a cylindrical metal flow passage covering part 64, which is disposed such that the flow passage covering part 64 covers the outer surface 62a of the pipe 62, and metal small rod-shaped connection parts 66A, 66B and 66C (in FIG. 6B, the number of connection parts is twelve, for example), which connect the pipe 62 and the flow passage covering part 64, are built at the same time.

A shape (especially, a shape of a surface facing the pipe 62) of the flow passage covering part 64 is similar to or the same as the outer surface 62a of the pipe 62. In other words, the shape of the flow passage covering part 64 imitates the outer surface 62a, which is a fluid polishing target, of the pipe 62. In this case, a distance between the outer surface 62a of the pipe 62 and the flow passage covering part 64 (i.e., width of a flow passage 68) remains roughly constant regardless of position, and it is possible that the polishing liquid G smoothly flows in the flow passage 68, which is an area surrounded by the outer surface 62a of the pipe 62 (i.e., a target surface of fluid polishing) and the flow passage covering part 64. In the build apparatus 4 illustrated in FIG. 2, as an example, the control apparatus 20 can generate 3D data of the flow passage covering part 64 and connection parts 66A-66C by using 3D data of the pipe 62, and the build apparatus 4 can build the pipe 62, the flow passage covering part 64 and connection parts 66A-66C by using the above-mentioned procedure.

As one example, there are four connection parts 66A at an upper end portion, four connection parts 66B at a middle, and four connection parts 66C at a lower end portion between the pipe 62 and the flow passage covering part 64. Arrangement and number of connection parts 66A-66C are arbitrary. Incidentally, connection parts 66A-66C can be considered as part of the flow passage covering part 64. A structure, in which the pipe 62 and the flow passage covering part 64 are connected, is the polishing target 70 of this embodiment. In the fluid polishing apparatus 6 illustrated in FIG. 1, a portion contacting the flow passage 68 is fluid polished by supplying the polishing liquid GL into the flow passage 68 in the polishing target 70. As one example, although a height of the pipe 68 and a height of the flow passage covering part 64 are the same, the height of the pipe 68 and the height of the flow passage covering part 64 may differ from each other.

Moreover, in this embodiment, after fluid polishing the polishing target 70 (the flow passage 68), the flow passage covering part 64 is removed by crushing or breaking using a hammer used by a worker, an electric polisher having a relatively thin rotating blade (a tip saw), or an electric cutter having a straight blade (a blade saw). At the same time, connection parts 66A-66C are also removed by crushing or the like. In this case, the flow passage covering part 64 and connection parts 66A-66C are preferably of crushable or breakable constructions. To do this, it is preferable that a thickness of the flow passage covering part 64 is as thin as possible within a range in which the polishing liquid GL can be stably supplied. Similarly, the connection parts 66A-66C are set to have a thickness and width that is approximately the same as or thinner than that of the flow passage covering part 64. In this embodiment, as illustrated in the plan view of FIG. 6C, as an example, the thickness d2 of the flow passage covering part 64 is set to be thinner than the thickness d1 of the pipe 62. Also, the width d3 of the flow passage 68 (see FIG. 6E) is set to be wider than the thickness d2 of the flow passage covering part 64. Therefore, the polishing liquid GL can be supplied to the flow passage 68 at a desired flow rate per unit time. However, the width d3 of the flow passage 68 may be set to be equal to or smaller than the thickness d2 of the flow passage covering part 64.

Moreover, as an example, the thickness d2 of the flow passage covering part 64 is preferable range of 0.5-1 mm. If the thickness d2 is equal to or more than 0.5 mm, it is possible to stably flow the polishing liquid GL to the flow passage 68 at a desired flow rate per unit time. On the other hand, if the thickness d2 is equal to or less than 1 mm, it is possible to easily crush or break the flow passage covering part 64 after fluid polishing. Incidentally, if the thickness of the flow passage covering part 64 is different depending on the position, as the thickness d2, it may be used thickness obtained by averaging the thickness for each different position.

Moreover, in this embodiment, after fluidic polishing, when crushing the flow passage covering part 64 and the connection parts 66A-66C, as illustrated in FIG. 6D, residue 66Aa-66Ca of connection parts 66A-66C may remain at the outer surface 62a of the pipe 62. In this case, a worker may scrap the residue 66Aa-66Ca and may polish a surface after scraping using such as an electric polishing machine. Such partial polishing can be easily performed in a short time.

Moreover, in order to reduce or easily scrape the residual 66Aa-66Ca of the connection parts 66A-66C in the outer surface of the pipe 62, instead of the connection part 66A width is uniform, as illustrated in FIG. 6E, a connection part 66A1, in which the width we1 (thus cross-sectional area) of the pipe 62 side is smaller than the width we2 (thus cross-sectional area) of the flow passage covering portion 64 side, may be used. Such connection part 66A1 is easy crushed, and since the connection part 66A1 is crushed at a portion close to the pipe 62, it is easy to subsequent polishing or the like.

Furthermore, in order to easily perform crushing of the flow passage covering part, as illustrated in FIG. 6F, instead of the flow passage covering part 64, a porous-shaped or porous flow passage covering part 64P, which has a large number of voids 64Pa or pores (porous) inside, may be provided. Such porous-shaped or porous flow passage covering part 64P can stably flow the polishing liquid GL to the flow passage 68. Furthermore, after fluid polishing, it is possible to easily perform crushing of the flow passage covering part 64P.

Moreover, in FIG. 6B, the connection parts 66A and 66C may be provided at a position, at which a straight blade of an electric cutter or the like can be easily inserted from the outside, e.g., only the upper end side and the lower end side positions, between the pipe 62 and the flow passage covering part 64. In this case, instead of crushing the flow passage covering part 64 after fluid polishing, crushing or cutting only the connection part 66A at the upper end side and the connection part 66C at the lower end side by using the above-mentioned straight blade or the like, thereby the flow passage covering part 64 may be removed. In this case, it is possible to remove the flow passage covering part 64 from the pipe 62 more easily than crush the entire flow passage covering part 64. In other words, a method for removing the flow passage covering part 64 from the pipe 62 (the build object) is not limited to crushing/breaking of the entire flow passage covering part, may be cutting/breaking only a part (connection part) of the flow passage covering part, for example.

Next, when the polishing target 70 of FIG. 6B is fluid polished by the fluid polishing apparatus 6 of FIG. 1, as illustrated in FIG. 7A, the supply jig 58, the polishing target 70, and the discharge jig 60 are put between the piping 44C for supplying and the piping 44D for discharging of the fluid polishing apparatus 6 as an example. Incidentally, in FIG. 7A or the like, the connection parts 66A-66C of the polishing target 70 is not illustrated.

In the cross-sectional view illustrated in FIG. 7A, the piping 44C is connected to a recess of the upper end (the piping 44C side) of the short cylindrical supply jig 58, and a disk-shaped flow passage branch part 58b, which substantially covers the inner surface 62b of the pipe 62, is provided at a deep recess of the lower end side (the polishing target 70 side) of the supply jig 58 through a plurality of connection parts 58c. As illustrated in the bottom view of the supply jig 58 of FIG. 7B, as an example, the flow passage branch port 58b is connected to the supply jig 58 via four (plurality of) connection parts 58c.

Furthermore, the flow passage covering part 64 of the polishing target 70 is inserted into the recess 58a of the lower end of the supply jig 58. Incidentally, sealing materials (e.g., O-rings) may be provided between the piping 44C and the supply jig 58, and between the supply jig 58 and the flow passage covering part 64, respectively, thereby the polishing liquid GL leakage to the outside may be reduced. In this case, the cylindrical flow passage 58d between the supply jig 58 and the flow passage branch part 58b communicates with a flow passage in the piping 44C and the cylindrical flow passage 68 of the polishing target 70.

Moreover, the piping 44D is connected to a recess of the lower end (the piping 44D side) of the short cylindrical discharge jig 60, and a deep recess (a cylindrical flow passage 60b) is provided at the upper end side (the polishing target 70 side) of the discharge jig 60 so that the deep recess covers the flow passage 68 of the polishing target 70 and a space in the inner surface 62b. Furthermore, the flow passage covering part 64 of the polishing target 70 is inserted into the recess 60a of the upper end of the discharge jig 60. Incidentally, sealing materials (e.g., O-rings) may be provided between the piping 44D and the discharge jig 60, and between the discharge jig 60 and the flow passage covering part 64, respectively, thereby the polishing liquid GL leakage to the outside may be reduced. In this case, the flow passage 60b in the discharging jig 60 communicates with the cylindrical flow passage 68 of the polishing target 70, the space surrounded by the inner surface 62a of the polishing target 70 (the pipe 62), and the flow passage in the piping 44D.

Therefore, the polishing liquid GL supplied (pumped) from the cylinder 48 of FIG. 1, as illustrated by the arrow A1 in FIG. 7A, flows from the piping 44C into the flow passage 58d in the supply jig 58. Furthermore, the polishing liquid GL after passing through the flow passage 58d, flows into the flow passage 68 of the polishing target 70 as illustrated by the arrow A2. Then, the polishing liquid GL, which has flowed through the flow passage 68, flows from the flow passage 68 to the flow passage 60b of the discharging jig 60 as indicated by the arrow A3. Thereafter, the polishing liquid GL is collected to the collection tank 50 of FIG. 1 through the piping 44D as indicated by the arrow A4. In this way, by flowing the polishing liquid GL with a predetermined flow rate per unit time in the flow passage 68 of the polishing target 70 for a predetermined supply time, the outer surface 62a of the pipe 62 contacting with the flow passage 68 is fluid polished, thereby the surface roughness of the outer surface 62a becomes smooth. Incidentally, the predetermined flow rate per unit time, and the predetermined supply time may be values empirically obtained by actually fluid polishing another polishing target, for example. The empirically obtained values are stored in the storing part of the main control apparatus 8, and the values are outputted from the main control apparatus 8 to the control apparatus 56 of the fluid polishing apparatus 6 as required, for example.

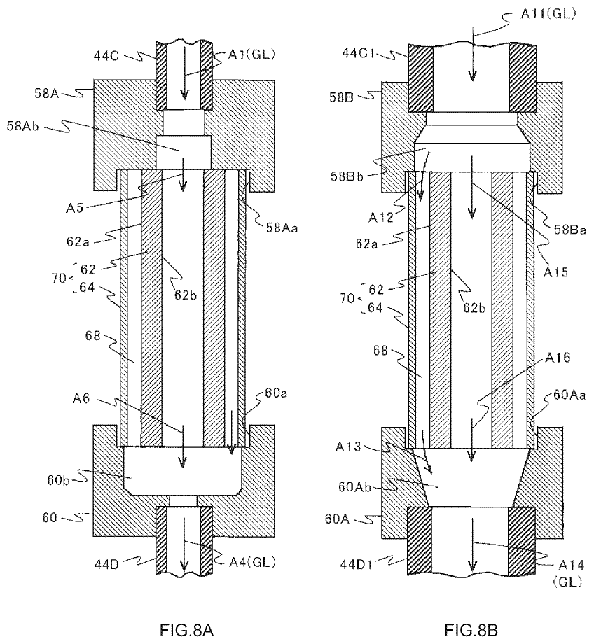

Furthermore, in order to perform fluid polishing of the inner surface 62b of the pipe 62 of the polishing target 70, for example, as illustrated in FIG. 8A, the supply jig 58 may be replaced with another supply jig 58A. In FIG. 8A, a recess of the upper end (the piping 44C side) of the cylindrical supply jig 58A is connected to the piping 44C, and the flow passage covering part 64 of the polishing target 70 is inserted into a recess 58Aa of the lower end side (the polishing target 70 side) of the supply jig 58A. In this case, a cylindrical flow passage 58Ab in the supply jig 58A communicates with the space in the inner surface 62b of the pipe 62 of the polishing target 70 and the flow passage in the piping 44C. Configuration of the discharge jig 60 is the same as FIG. 7A.

In this case, the polishing liquid GL supplied (pumped) from the cylinder 48 of FIG. 1, as illustrated by the arrow A1 in FIG. 8A, flows from the piping 44C into the flow passage 58Ab in the supply jig 58A. Furthermore, after passing through the flow passage 58Ab, the polishing liquid GL flows into the inner surface 62b of the pipe 62 of the polishing target 70 as illustrated by the arrow A5. Then, the polishing liquid GL, which has flowed through an area in the inner surface 62b, flows into the flow passage 60b of the discharge jig 60 as indicated by the arrow A6. Thereafter, the polishing liquid GL is collected to the collection tank 50 of FIG. 1 through the piping 44D as indicated by the arrow A4. In this way, by flowing the polishing liquid GL, the inner surface 62b of the pipe 62 is smoothly fluid polished. Since the space surrounded by the inner surface 62b of the pipe 62 is a closed space, the polishing liquid GL can be efficiently flowed in this condition. Incidentally, for example, when a caliber (a diameter) of the inner surface 62b is large, a cylindrical flow passage covering part (not illustrated) is also built at inside of the inner surface 62b, and then, the polishing liquid GL flows between the flow passage covering part and the inner surface 62b, the flow passage covering part may be removed after fluid polishing.

Moreover, for example, when the volume of the cylinder 48 in FIG. 1 is large, as illustrated in a modification of FIG. 8B, instead of piping 44C and 44D, by using piping 44C1 and 44D1 having a large cross-sectional area, the polishing liquid GL can flow to both of the flow passage 68 of the polishing target 70 and an area in the inner surface 62b of the pipe 62.

In FIG. 8B, the large piping 44C1 is connected to a recess of the upper end (the piping 44C1 side) of the cylindrical supply jig 58B, and the flow passage covering part 64 of the polishing target 70 is inserted into a recess 58Ba of the lower end side (the polishing target 70 side) of the supply jig 58. Furthermore, the cylindrical flow passage 58Bb in the supply jig 58B communicates with both of the flow passage 68 of the polishing target 70 and an area in the inner surface 62b of the pipe 62.

Similarly, the large piping 44D1 is connected to a recess of the lower end (the piping 44D1 side) of the cylindrical discharge jig 60A, and the flow passage covering part 64 of the polishing target 70 is inserted into a recess 60Aa of the upper end side (the polishing target 70 side) of the discharge jig 60A. Furthermore, the cylindrical flow passage 60Ab in the discharge jig 60A communicates with both of the flow passage 68 of the polishing target 70 and an area in the inner surface 62a of the pipe 62, and a flow passage in the piping 44D1.

In this modification, the polishing liquid GL supplied (pumped) from the cylinder 48 of FIG. 1, as illustrated by the arrow A11 in FIG. 8B, flows into the flow passage 58Bb in the supply jig 58B from the piping 44C1. Furthermore, after passing through the flow passage 58Bb, the polishing liquid GL flows into the flow passage 68 of the polishing target 70 as illustrated by the arrow A12 and flows into the inner surface 62b of the pipe 62 of the polishing target 70 as illustrated by the arrow A15, at the same time. Then, the polishing liquid GL, which has flowed through the flow passage 68, flows into the flow passage 60Ab of the discharge jig 60A as illustrated by the arrow A13, and the polishing liquid GL, which has flowed through the area in the inner surface 62b, flows into the flow passage 60Ab of the discharge jig 60A as illustrated by the arrow A16. Thereafter, the polishing liquid GL is collected to the collection tank 50 of FIG. 1 through the piping 44D1 as illustrated by the arrow A14. In this way, by flowing the polishing liquid GL, both of the outer surface 62a, which contacts with the flow passage 68 of the polishing target, of the pipe 62 and the inner surface 62b of the pipe 62 are smoothly fluid polished. In this modification, since both of the outer surface 62a and the inner surface 62b of the pipe 62 can be fluid polished at the same time, it is possible to perform fluid polishing efficiently.

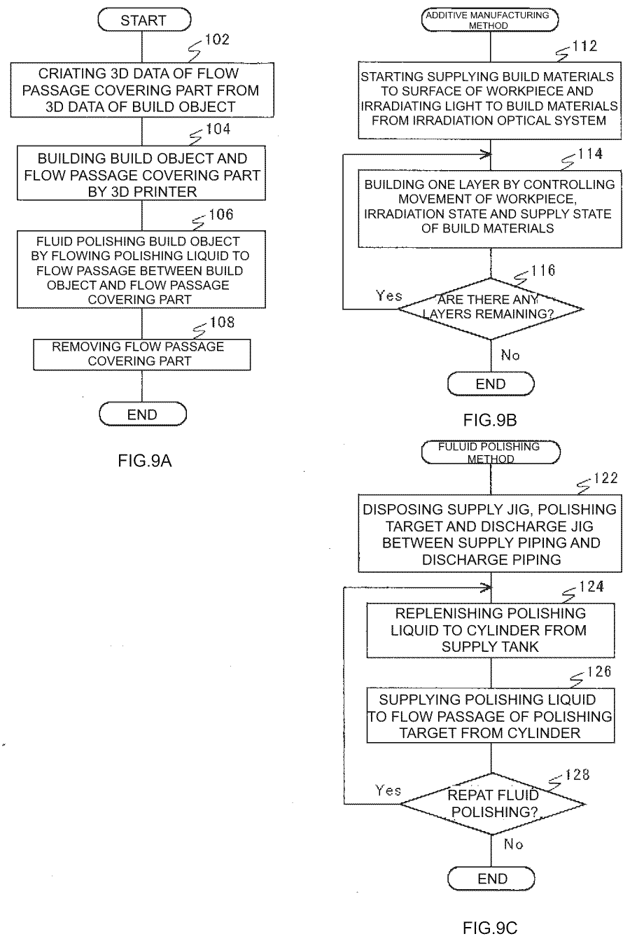

Next, one example of series of operations when a build target (here, the pipe 62) is built by the build system 2 of this embodiment will be described with referring to flowcharts of FIGS. 9A, 9B and 9C. FIG. 9A illustrates basic operation of the build system 2. In this case, as an example, it is assumed that 3D data of the pipe 62 (three-dimensional model data) is supplied to the control apparatus 20 of the build apparatus 4 from the main control apparatus 8. Furthermore, it is assumed that control information, which instructs to build the flow passage 64 and the connection parts 66A-66C at the outer surface 62a of the pipe 62, is also supplied to the control apparatus 20 from the main control apparatus 8. In the step 102 of FIG. 9A, the control apparatus 20 create 3D data of the flow passage covering part 64 and the connection parts 66A-66C from the 3D data of the pipe 62 (the build target or the build object). At this time, in the control apparatus 20, 3D data of a plurality of layers (partial data of each of a plurality of structural layers SL) are created by performing a slicing process, in which 3D data of the pipe 62, the flow passage covering part 64 and the connection parts 66A-66C are slicing by a layer pitch.

In the next step 104, in the build apparatus 4 (a 3D printer), the polishing target 70 including the pipe 62, the flow passage covering part 64 and the connection parts 66A-66C is built, as illustrated in FIG. 6B, by using 3D data of the pipe 62, the flow passage covering part 64 and the connection parts 66A-66C. The built polishing target 70 is transported to the fluid polishing apparatus 6 of FIG. 1. Then, in the step 106, in the fluid polishing apparatus 6, as illustrated in FIG. 7A, the outer surface 62a of the pipe 62 is fluid polished by flowing the polishing liquid GL to the flow passage 68 between the pipe 62 and the flow passage covering part 64. Thereafter, the supply jig 58 and the discharge jig 60 are removed from the polishing target 70.

Then, in the step 108, for example, most of the flow passage covering part 64 and the connection parts 66A-66C are removed by a worker using a hammer, an electric polisher, an electric cutter, or the like crushing or breaking the flow passage covering part 64 and the connection parts 66A-66C of the polishing target 70, as illustrated in FIG. 6D. Thereafter, for example, if the residual 66Aa-66Ca of the connection parts 66A-66C is left, the entire outer surface 62a of the pipe 62 is smoothly polished by the worker using such as the electric polisher partially polishing a part of the residual 66Aa-66Ca.

Next, the more detailed operation of the step 104 is steps 112-116 of FIOG. 9B. Namely, in the step 112, supplying the build materials M (here, metal) from the material nozzle 32 of the build apparatus 4 to the supply area MA of the surface of the workpiece W, and irradiating the light EL from the irradiation optical system 30 to the irradiation area EA of the surface of the workpiece W are started. Then, in the step 114, building a first layer of the pipe 62, the flow passage covering part 64 and the connection parts 66A-66C is performed by controlling movement of the workpiece W, an irradiation state of the light EL and a supply state of the build materials M by using a partial data of a structural layer SL of the first layer of the pipe 62, the flow passage covering part 64 and the connection parts 66A-66C. Then, in the step 116, the control apparatus 20 determines whether or not there are any remaining layers to be built. If there are remaining layers to be built, the step 114 is repeated to build a second layer, a third layer, etc. In this way, the pipe 62, the flow passage covering part 64 and the connection parts 66A-66C is built.

Next, the more detailed operation of the step 106 is steps 122-128 of FIG. 9C. Namely, in the step 122, as illustrated in FIG. 7A, the supply jig 58, the polishing target 70 and the discharge jig 60 are provided between the piping 44C (supply piping) and the piping 44D (discharge piping) of the fluid polishing apparatus 6 of FIG. 1. At this time, control information, which includes, for example, flow rate of the polishing liquid GL supplied per unit time from the main control apparatus 8 to the polishing target 70, and time for supplying the polishing liquid GL, is supplied to the control apparatus 56 of the fluid polishing apparatus 6.

In the next step 124, the polishing liquid GL is refilled from the supply tank 42 to the cylinder 48. Then, in the step 126, the polishing liquid GL in the cylinder 48 is supplied to the flow passage 68 of the polishing target 70 at a set flow rate per unit time. In the next step 128, the control apparatus 56 determines whether or not the time, in which the polishing liquid GL has been supplied (polishing time), reaches the set time, and then the steps 124 and 126 (i.e., refilling the polishing liquid GL to the cylinder 48 and pumping the polishing liquid GL from the cylinder 48 to the polishing target 70) are repeated in order to repat fluid polishing when the polishing time has not reached the set time. Fluid polishing the polishing target 70 is terminated when fluid polishing the polishing target 70 reaches the set time.

In this way, according to the build method of this embodiment, the flow passage covering portion 64 is built at the same time in building the pipe 62 of the build target, then the polishing liquid GL is supplied to the flow passage 68 between the outer surface 62a of the pipe 62 and the flow passage covering part 64. Since the flow passage 68 is formed by the flow passage covering part 64, it is possible to efficiently fluid polish the outer surface 62a contacting the flow passage 68 even if it is difficult to mechanical polish and fluid polish the outer surface 62a of the pipe 62 just as it is.

As described above, the build method of this embodiment is a method for forming a three-dimensional build object (the pipe 62 as an example) which includes the step 104, in which the flow passage covering part 64 (a flow passage forming part), which is disposed such that the flow passage covering part 64 faces the pipe 62 and (at least a part of) the outer surface 62a of the pipe 62, is built with additive manufacturing (the AM method), and the step 106, in which the portion (i.e., the outer surface 62a), which contacts with the flow passage 68, of the pipe 62 is fluid polished by passing polishing liquid GL (polishing fluid) through the flow passage 68 between the pipe 62 and the flow passage covering part 64, and the step 108, in which the flow passage covering part 64 is removed by crashing, breaking, or the like.

Moreover, the build system 2 of this embodiment is a build system for forming a three-dimensional build object (the pipe 62 as an example) which is provided with the build apparatus 4, which builds the pipe 62 and the flow passage covering part 64 with additive manufacturing (the AM method), and the fluid polishing apparatus 6, which fluid polishes a portion (i.e., the outer surface 62), which contacts with the flow passage 68, of the pipe 62 by passing the polishing liquid GL through the flow passage 68 between the pipe 62 and the flow passage covering part 64.

According to this embodiment, only the flow passage covering part 64 is built such that the flow passage covering part 64 covers a part, surface roughness of which is smoothed, even when surface roughness of the pipe 62 built by the AM method is rough, and it is difficult to perform efficiently mechanical polishing or fluid polishing. Then, by supplying the polishing liquid GL to the flow passage 68 covered by the flow passage covering portion 64, and then removing the flow passage covering portion 64, it is possible to efficiently smooth fluid polish the portion, which contacts with the flow passage 68, of the pipe 62.

Moreover, as illustrated in FIG. 7A, when fluid polishing is performed by connecting the supply jig 58, which has the flow passage 58d communicating with the flow passage 68, with the polishing target 70 (the pipe 62), it is possible to flow intensively the polishing liquid GL to the flow passage 68 covered by the flow passage covering part 64. Therefore, it is possible to efficiently fluid polish the portion contacting with the flow passage 68.

Moreover, as illustrated in the modification of FIG. 8B, when fluid polishing is performed by connecting the supply jig 58B, which has the flow passage 58Bb communicating with the flow passage 68 and the inner of the inner surface 62b of the pipe 62, with the polishing target 70, it is possible to efficiently flow the polishing liquid GL to the outer surface 62a, which contacts with the flow passage 68, and the inner of the inner surface 62b of the pipe 62. Therefore, it is possible to efficiently fluid polish the outer surface 62a and the inner surface 62b of the pipe 62 at the same time.

Incidentally, in the above-mentioned embodiment, the polishing liquid GL, which has passed through the flow passage 68 of the polishing target 70, may be directly led to the collection tank 50 without using the discharge jig 60 and the piping 44D. Furthermore, the polishing liquid GL supplied from the piping 44C may be directly led to the flow passage 68 of the polishing target 70 without using the supply jig 58 when the cross-sectional shape of the piping 44C is similar to the shape of the entrance of the flow passage 68 of the polishing target 70, when the cross-sectional shape of the piping 44C is larger than the shape of the entrance of the flow passage 68 of the polishing target 70, or the like.

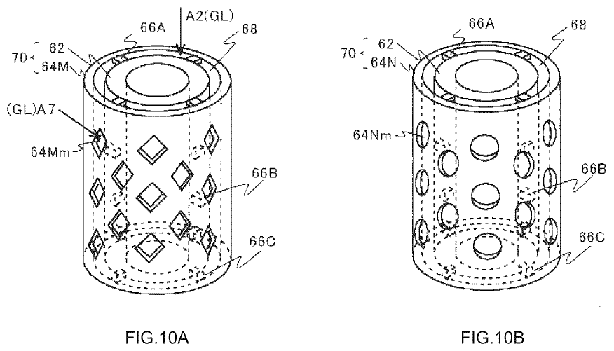

Moreover, in the above-mentioned embodiment, since the polishing liquid GL can not pass through the flow passage covering part 64 and 64P provided in the pipe 62, it is possible to efficiently flow the polishing liquid GL only the flow passage 68 covered by the flow passage covering part 64 and 64P. In contrast, as illustrated in FIG. 10A, the flow passage covering part 64M, in which a large number of rectangular openings 64Mm are regularly formed, may be built as a flow passage covering part covering the outer surface of the pipe 62. The flow passage covering part 64M may be a mesh-like or reticulated. Incidentally, when the opening 64Mm is large, since the amount of leakage of the polishing liquid GL outer side from the opening 64Mm is increased, the size of the opening 64Mm (size of mesh) is preferably fine such that the amount of leakage of the polishing liquid GL is some extent suppressed. Moreover, the flow passage covering part 64M may be a structure having a large number of crevices therein (e.g., pumice-like structure). Moreover, when the flow passage covering portion 64M is used, as illustrated by the arrow A7, the polishing liquid GL may be supplied to the flow passage 68 from the outside through the large number of openings 64Mm. Therefore, it is possible to perform fluid polishing of the portion, which contacts with the flow passage 68, of the pipe 62 quickly by using both of supplying the polishing liquid GL from the upper portion illustrated by the arrow A2 and supplying the polishing liquid GL from the side illustrated by the arrow A7 when it is possible to increase flow rate of the polishing liquid GL.

Moreover, as illustrated in FIG. 10B, the flow passage covering part 64N, in which a large number of circular openings 64Nm are regularly formed, may be built as a flow passage covering part covering the outer surface of the pipe 62. The flow passage covering portion 64N can also be referred to as mesh-like or reticulated. Similarly, when the flow passage covering portion 64N is used, it is possible to perform fluid polishing of the portion, which contacts with the flow passage 68, of the pipe 62 quickly by using both of supplying the polishing liquid GL from the upper portion and supplying the polishing liquid GL from the side. Also in this example, the size of the opening 64Nm is preferably fine such that the amount of leakage of the polishing liquid GL is some extent suppressed.

Moreover, in the above-mentioned embodiment, the pipe 62 is built as a build target, even when building anything other than the pipe 62 as the build target, it is possible to perform fluidic polishing by building a corresponding flow passage covering part.

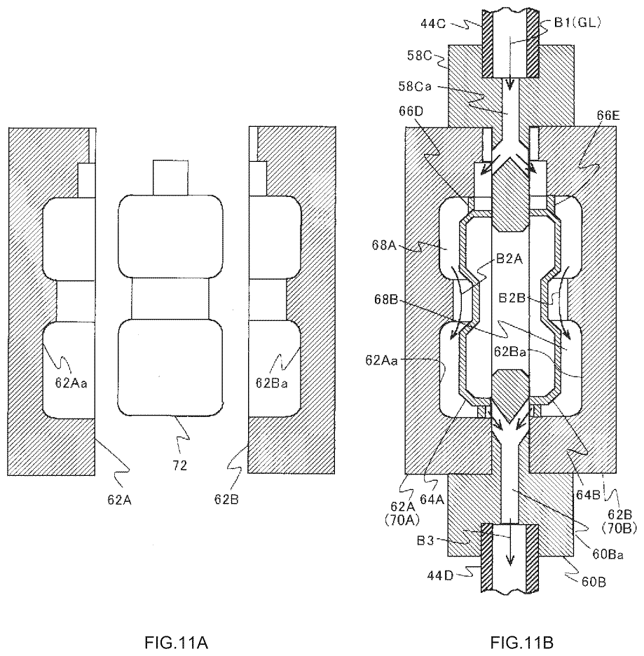

FIG. 11A is a cross-sectional view illustrating when the build target is two molds (i.e., metallic molds) 62A and 62B of a PET bottle 72. The molds 62A and 62B have inner surfaces 62Aa and 62Ba having shapes, which are the same as the one and the other of outer surface shapes when the outer surface shape of the PET bottle 72 is divided, as an example. When the molds 62A and 62B are built by using a 3D printer with the AM (additive manufacturing) method, it is difficult to polish inner surfaces 62Aa and 62Ba of the molds 62A and 62B just as it is. Therefore, it is assumed that the above-mentioned build method is applied to building the molds 62A and 62B. In this case, as illustrated in FIG. 11B, when the molds 62A and 62B are built, flow passage covering parts 64A and 64B are built at the same time such that the flow passage covering parts 64A and 64B cover the inner surfaces 62Aa and 62Ba of the molds 62A and 62B, respectively.

Shapes of the flow passage covering parts 64A and 64B is substantially the same as the shapes of the inner surfaces 62Aa and 62Ba of the molds 62A and 62B, i.e., imitate the shapes of the inner surfaces 62Aa and 62Ba. Moreover, distances between the flow passage covering parts 64A and 64B and the corresponding inner surfaces 62Aa and 62Ba are substantially constant, and between both end portions of each of the flow passage covering parts 64A and 64B and both end portions of each of the corresponding inner surfaces 62Aa and 62Ba, crevices (a supply opening and a discharge opening for the polishing liquid GL), that are the same degree as the crevices, are provided. Moreover, a plurality of connection parts 66D and 66E for connecting the flow passage covering parts 64A and 64B with the molds 62A and 62B are built at a part of crevice between the both end portions of each of the flow passage covering parts 64A and 64B and the both end portions of each of the corresponding inner surfaces 62Aa and 62Ba. Therefore, the flow passage covering parts 64A and 64B is supported by the molds 62A and 62B, the flow passages 68A and 68B, in which the polishing liquid GL can flow, are provided between the flow passage covering parts 64A and 64B and the inner surfaces 62Aa and 62Ba of the molds 62A and 62B.

In this modification, the mold 62A, the flow passage covering part 64A and the connection part 66D form one polishing target 70A, and the mold 62B, the flow passage covering part 64B and the connection part 66E form another polishing target 70B. In this modification, two polishing target 70A and 70B are fluid polished at the same time by using the fluid polishing apparatus 6 of FIG. 1 as an example. For this purpose, as illustrated in FIG. 11B, the supply jig 58C and the discharge jig 60B are used.

In FIG. 11B, the piping 44C is connected with the recess of the upper end (the piping 44C side) of the supply jig 58C, the outer shape of which is prismatic shape, the polishing targets 70A and 70B are disposed at both sides of the convex portion of the lower end (the polishing targets 70A and 70B side) of the supply jig 58C, and the flow passage 58Ca, which communicates with the flow passage in the piping 44C and flow passages 68A and 68B, is formed in the supply jig 58C. Similarly, the piping 44D is connected with the recess of the lower end (the piping 44D side) of the discharge jig 60B, the outer shape of which is prismatic shape, the polishing targets 70A and 70B are disposed at both side of the convex portion of the upper end (the polishing targets 70A and 70B side) of the discharge jig 60B, and the flow passage 60Ba, which communicates with the flow passage in the piping 44D and the flow passages 68A and 68B, is formed in the discharge jig 60B. Moreover, with respect to the crevices in a direction perpendicular to the paper surface of FIG. 11B between the molds 62A and 62B and the flow passage covering parts 64A and 64B, for example, the crevices are covered with water-repellent tape, and the tape may be fixed with an adhesive tape or the like.

When the polishing targets 70A and 70B of this modification are fluid polished, the supply jig 58C of FIG. 11B is connected with the piping 44C of the fluid polishing apparatus 6 of FIG. 1, and the discharge jig 60B is connected with the piping 44D of FIG. 1. Then, as illustrated by the arrow Bi, the polishing liquid GL is supplied (pumped) to the flow passage 58Ca in the supply jig 58C from the cylinder 48 of the fluid polishing apparatus 6 through the piping 44C. The supplied polishing liquid GL, as illustrated by arrows B2A and B2B, flows the flow passage 68A of the inner surface 62Aa of the mold 62A and the flow passage 68B of the inner surface 62Ba of the mold 62B, after that, flows from the flow passage 60Ba in the discharge jig 60B into the piping 44D as illustrated by the arrow B3. By continuing to supply the polishing liquid GL for a determined time, it is possible to fluid polish the inner surfaces 62Aa and 62Ba contacting with the flow passages 68A and 68B.

Thereafter, by removing the supply jig 58C and discharge jig 60A from the polishing targets 70A and 70B and removing the flow passage covering parts 64A and 64B and the connection parts 66D and 66E by crushing or the like, the molds 62A and 62B, in which the inner surfaces 62Aa and 62Ba are fluid polished, can be built. Incidentally, in this modification, the flow passage covering parts 64A and 64B are connected to the molds 62A and 62B only at around the inlet and the outlet of the fluid passage 68A and 68B, respectively, through the connection parts 66D and 66E. Furthermore, the connection parts 66D and 66E are in positions visible from the flow passage covering parts 64A and 64B. Therefore, only the connection parts 66D and 66E may be removed by crashing, breaking, or the like by using an electronic cutter having straight blade, for example. In this way, by removing the connection parts 66D and 66E, the flow passage covering parts 64A and 64B can be removed from the molds 62A and 62B.

In this modification, since two polishing targets 70A and 70B can be fluid polished at the same time by using the supply jig 58C, it is possible to perform the fluid polishing of the polishing targets 70A and 70B efficiently. Incidentally, in this modification, the discharge jig 60B and the piping 44D are omitted, the polishing liquid GL, which has flowed through the flow passages 68A and 68B of the polishing targets 70A and 70B, may be directly collected in the collection tank 50. Moreover, the polishing targets 70A and 70B may be individually fluid polished.

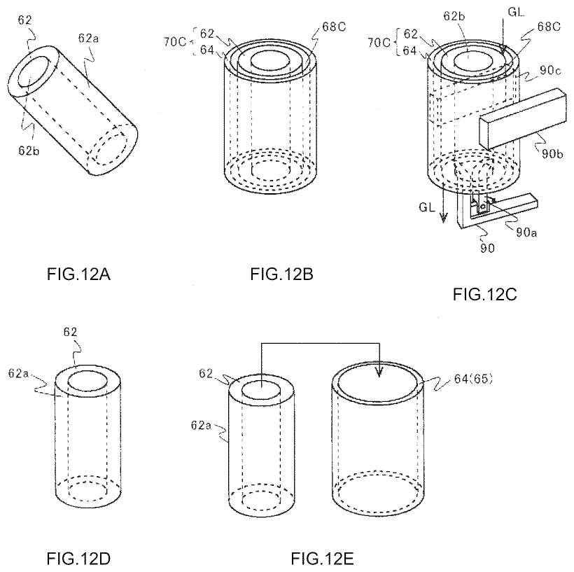

Moreover, in the above-mentioned embodiment, since the build target and the flow passage covering part are integrally built in the build apparatus 4, it is easy to support the polishing targets 70,70A and 70B. As another modification, as illustrated in FIGS. 12A-12D, in the build apparatus 4, the build target and the flow passage covering part may be built at the same time and in a separable condition. Also in this modification, it is assumed that the build is the pipe 12 of FIG. 12A. In this case, in the build apparatus 4, as illustrated in FIG. 12B, the pipe 62 and the flow passage covering part 64 are built at the same time and in a separable condition. At this time, since the connection parts 66A-66C between the pipe 62 and the flow passage covering part 64 are not provided, the pipe 62 and the flow passage covering part 64 can be separated.

Also in this modification, the pipe 62 and the flow passage covering part 64, which is disposed such that the flow passage covering part 64 surrounds the pipe 62, are referred to as the polishing target 70C. When the polishing target 70C is supported in fluid polishing apparatus 6, the inner surface 62b of the pipe 62 is supported from the inside by the tip portion 90, which protrudes from a main body portion (not illustrated) of a support apparatus, and the claw portion 90a, which is rotated by a motor (not illustrated) with respect to the tip portion 90, as illustrated in FIG. 12C. Furthermore, the side of the flow passage covering part 64 is supported by two pressing portions 90b and 90c protruding from the man body portion (not illustrated) of the support apparatus such that a distance between the pipe 62 and the flow passage covering part 64 is constant. In this condition, by flowing (pumping) the polishing liquid GL supplied from the piping 44C of the fluid polishing apparatus 6 of FIG. 1 to the flow passage 68C between the pipe 62 and the flow passage covering part 64, the outer surface of the pipe 62 is fluid polished. Thereafter, by removing the pipe 62 and the flow passage covering part 64 from the support apparatus, and by removing the flow passage covering part 64 from the pipe 62, the entire surface of the outer surface 62a of the pipe 62 is smoothed, as illustrated in FIG. 12D.

Furthermore, thereafter, when an other pipe (not illustrated), which has the same shape as the pipe 62, is built, by covering the other pipe with the removed flow passage covering part 64, it is also possible to perform fluid polishing the other pipe.

Moreover, in the above-mentioned embodiment and the modification thereof, in the build apparatus 4, the pipe 62 and the flow passage covering part 64 are built at the same time. As another modification, as illustrated in FIG. 12E, in the build apparatus 4, the pipe 62 and the flow passage covering part 64 may be built separately (at different times). Furthermore, instead of the flow passage covering part 64, the flow passage covering part 65, which is built by a method (such as machining) which differs from the additive manufacturing method, for example, may be used. Also in this case, by supporting the pipe 62 and the flow passage covering part 64 (or 65) such that the gap is constant as illustrated in FIG. 12C, the outer surface 62a of the pipe 62 can be fluid polished.

### Second Embodiment

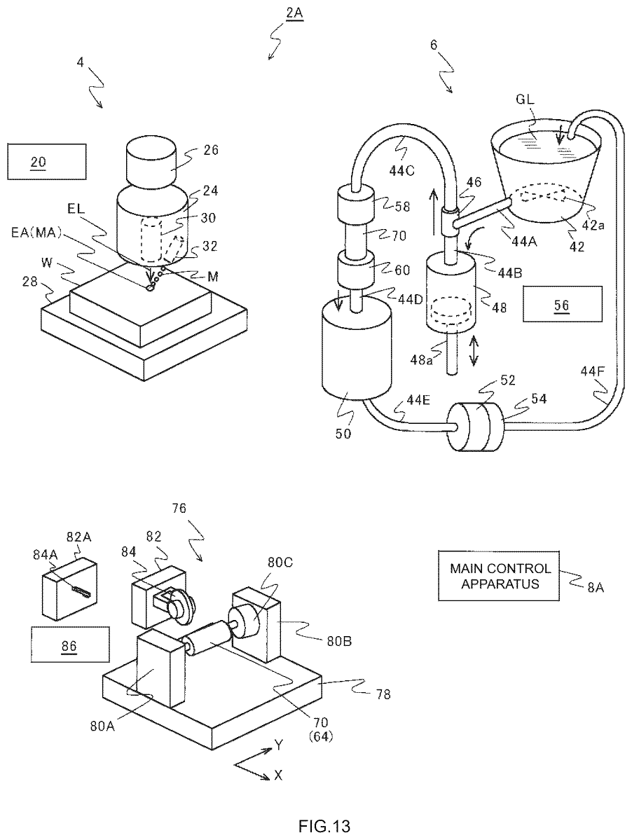

Hereinafter, a second embodiment will be described with reference to FIG. 13. Incidentally, in FIG. 13, parts corresponding to FIGS. 1 and 6A-D are gotten the same reference numerals and will not be described in detail.

FIG. 13 illustrates the build system 2A of this embodiment.

In FIG. 13, the build system 2A is provided with the build apparatus 4, which consists of a 3D printer, building a build target with the AM method, the fluid polishing apparatus 6 performing fluid polishing, the removing apparatus 76 removing an unnecessary part after fluid polishing, the main control apparatus 8A which consists of a computer controlling operations of the whole system, and a carrier system not illustrated. Configurations of the build apparatus 4 and the fluid polishing apparatus 6 are the same as the first embodiment. In the following description, it is assumed that the build target is the pipe 62 of FIG. 6A. In this case, in the build apparatus 4, the polishing target 70 including the pipe 62 and the flow passage covering part 64 is built as illustrated in FIG. 6B, in the fluid polishing apparatus 6, the polishing target 70 is fluid polished by supplying the polishing liquid GL to the flow passage 68 of the polishing target 70. Thereafter, the polishing target 70 is carried to the removing apparatus 76 via the carrier system not illustrated.

The removing apparatus 76 includes the stage 78 which is movable in two perpendicular directions (assumed as the X direction and the Y direction) in the horizontal plane, the support portions 80A and 80B, which provided on the stage 78, for supporting both ends of the polishing target 70, the rotating unit 80C for rotating the polishing target 70 with respect to the support portions 80A and 80B, the removing units 82 and 82A for removing the flow passage covering part 64 of the polishing target 70, the imaging unit (not illustrated) for imaging the polishing target supported by the support portions 80A and 80B and the control apparatus 86. As an example, the removing unit 82 has the rotary blade 84, the removing unit 82A has the straight blade 84A. Although the removing unit 82 is disposed at the use position in FIG. 13, a configuration capable of using the removing unit 82A in place of the removing unit 82 as required. The main control apparatus 8A outputs information of the shape of the pipe 62 and the flow passage covering part 64 of the polishing target 70 or the like to the control apparatus 86. The control apparatus 86 removes the flow passage covering part 64 by crushing or the like by driving the stage 78 and the removing unit 82 or 82A by using the information of the shape and imaging information of the imaging unit.

Specifically, when the removing unit 82 is used, the rotating unit 80C is stopped, the rotary blade 84 of the removing unit 82 is contacted with the flow passage covering part 64 of the polishing target 70, the stage 78 is moved in the Y direction while crushing the flow passage covering part 64 by the rotary blade 84, the portion, which corresponds to a first row along the Y direction, of the flow passage covering part 64 is crushed, and the rotary blade 84 is detached from the polishing target 70. Next, after rotating the polishing target 70 by an angle of one row by the rotating portion 80C, the rotary blade 84 is contacted with the flow passage covering part 64 of the polishing target 70, the stage 78 is moved in the Y direction while crushing a second row of the flow passage covering part 64 by the rotary blade 84. By repeating this operation, the flow passage covering part 64 of the polishing target 70 is removed.

Furthermore, as an example, it is assumed that the control apparatus 86 determines that the residual 66Aa-66Ca of the connection parts remain at the outer surface 62a of the pipe 62 as illustrated in FIG. 6D by using the imaging information of the imaging unit. At this time, the residual 66Aa-66Ca are polished by contacting the rotary blade 84 with the residual 66Aa-66Ca of the outer surface 62a of the pipe 62, and by rotating by the rotating unit 80C and moving the stage 78 in the Y direction. Thereby, the entire surface of the outer surface 62a of the pipe 62 becomes smooth.

Moreover, when polishing targets are the polishing targets 70A and 70B including molds 62A and 62B illustrated in FIG. 11B, for example, it is possible to remove the flow passage covering parts 64A and 64B by only removing the connection parts 66D and 66E. When the flow passage covering parts 64A and 64B are removed from the polishing targets 70A and 70B by using the removing apparatus 76 of FIG. 13, the removing unit 82A is used instead of the removing unit 82. Then, it is possible to remove the flow passage covering part 64A or 64B from the polishing target 70A or 70B by supporting the polishing target 70A or 70B by the supporting portions 80A and 80B, by actuating the blade 84A of the removing unit 82A, and by crushing or cutting the connection part 66D or 66E of the polishing target 70A or 70B. If a residue of the connection part 66D or 66E remains, the residue portion may be removed or polished by such as the blade 84, or the residue portion may be manually polished by a worker.

According to this embodiment, it is possible efficiently fluid polish the outer surface 62a of the pipe 62 along the flow passage 68 of the polishing target by the fluid polishing apparatus 6. Furthermore, after fluidic polishing, it is possible to remove the flow passage covering part 64 and the connection parts 66A-66B from the polishing target 70 in a short time by removal apparatus 76.

Incidentally, the configuration of the removing apparatus 76 is not limited to the configuration of FIG. 13, and any other configuration can be applied. Moreover, instead of the removing apparatus 76, for example, such as an apparatus, which removes a flow passage covering part of a polishing target by laser-light, ultrasonic, dissolution or the like, can be also used.

Moreover, in the above-mentioned embodiments, the Laser Melt Deposition method (LMD) of the Directed Energy Deposition method (DED) is used as the build apparatus 4 using the AM method. Incidentally, instead of the build apparatus 4, a build apparatus using the Directed Energy Deposition method (DED) other than the LMD method (e.g., a method in which a heat source is an arc plasma or an electron beam other than laser light), a build apparatus using the Powder Bed Fusion method (the PDF method), a build apparatus using the Binder Jetting method (the BJT method), or the like may be used. In the PDF process, for example, material powder is laid on a flat metallic plate, and a powder layer of a powder bed (Powder Bed) is made. A material layer is formed by melting and solidifying material powders by irradiating a laser beam or an electron beam to the layer while scanning along a shape of one layer of a sliced build object. When forming one layer is completed, a successive layer is formed in a new powder layer formed on a previous layer in order, thereby a three-dimensional build object is formed.

Moreover, in the BJT method, a powder-like build materials are laid on an entire build area, by ejecting binder for curing the build materials to only a portion to be built on a surface thereof from an ejection apparatus such as an ink jet head and curing the portion, building a layer is performed. A three-dimensional build object is formed by repeating this process.

Moreover, the configurations of the build system 2 and 2A of the above-mentioned embodiment are not limited to the above-mentioned configurations, and any other configuration can be applied.

### DESCRIPTION OF REFERENCE NUMERALS AND LETTERS

2, 2A . . . Build system, 4 . . . Build apparatus, 6 . . . Fluid polishing apparatus, 8 . . . Main control apparatus, 24 . . . Build head, 42 . . . Supply tank, 46 . . . Three-way valve, 48 . . . Cylinder, 50 . . . Collection tank, 58, 58A, 58B, 58C . . . Supply jig, 60, 60A, 60B . . . Discharge jig, 62 . . . Pipe, 62A, 62B . . . Mold, 64, 64A, 64B . . . Flow passage covering part, 66A-66E . . . Connection part, 70, 70A, 70B . . . Polishing target, 76 . . . Removing apparatus

1. A build method for forming a three-dimensional build object including:
building the build object by additive manufacturing;
forming a flow passage forming part so as to form a flow passage between the flow passage forming part and the build object;
passing polishing fluid through the flow passage along an extending direction of the flow passage so as to perform fluid polishing a portion, which faces the flow passage, of the build object; and
disassembling the flow passage forming part.

2. The build method according to claim 1, wherein
building the build object by additive manufacturing includes building the build object and the flow passage forming part by additive manufacturing at the same time.

3. The build method according to claim 1, wherein
a shape of the flow passage forming part imitates a shape of a portion, which faces the flow passage forming part, of the build object.

4. The build method according to claim 1, wherein
building the build object by additive manufacturing, and forming the flow passage forming part, include integrally building the build object and the flow passage forming part, which is disposed such that the flow passage forming part faces at least the portion of the build object, by additive manufacturing, and
disassembling the flow passage forming part includes removing the flow passage forming part from the build object.

5. The build method according to claim 4, wherein
disassembling the flow passage forming part includes crushing the flow passage forming part.

6. The build method according to claim 4, wherein
an interval between the flow passage forming part and a portion, which faces the flow passage forming part, of the build object is constant.

7. The build method according to claim 4, wherein
the build object and the flow passage forming part are connected through a plurality of connection parts.

8. The build method according to claim 7, wherein
in each of the plurality of connection parts, a cross-section area in the build object side is smaller than that in the flow passage forming part side.

9. The build method according to claim 7, wherein
disassembling the flow passage forming part includes removing the plurality of connection parts.

10. The build method according to claim 7, wherein
disassembling the flow passage forming part is performed by crushing or cutting the plurality of connection parts.

11. The build method according to claim 4, wherein
thickness of the flow passage forming part is thinner than thickness of the build object.

12. The build method according to claim 11, wherein
the thickness of the flow passage forming part is from 0.5 mm to 1 mm.

13. The build method according to claim 4, wherein
width of the flow passage is wider than thickness of the flow passage forming part.

14. The build method according to claim 4, wherein
a plurality of voids are formed in the flow passage forming part.

15. The build method according to claim 4, wherein
the flow passage forming part has a mesh shape.

16. The build method according to claim 4, wherein
building the build object and the flow passage forming part by additive manufacturing includes:
creating 3D data of the flow passage forming part on the basis of 3D data of the build object,
while supplying build material, irradiating an energy beam to at least a part of the build material from a beam irradiation part including a condensing optical system, and
controlling at least one of movement of an object, irradiation condition of the energy beam from the beam irradiation part, and supply condition of the build material on the basis of the 3D data of the build object and the 3D data of the flow passage forming part.

17. The build method according to claim 16, wherein
creating the 3D data of the flow passage forming part includes creating part data of a plurality of layers by performing slice processing to the 3D data of the build object and the 3D data of the flow passage forming part at a laminate pitch, and
repeating performing to build one layer by controlling at least one of movement of the object, the irradiation condition of the energy beam from the beam irradiation part, and the supply condition of the build material for each part data of the plurality of layers.

18. The build method according to claim 1, wherein
a polishing liquid is a mixture of an abrasive and a liquid medium, the abrasive is selected from a group of abrasives including diamond, cerium oxide, cubic boron nitride, silicon carbide, tungsten carbide, boron carbide alumina and silicon dioxide, the liquid medium is selected from a group of liquid media including water, silicon oil, organic solvent and oil.

19. The build method according to claim 1, wherein
performing fluid polishing the portion, which faces the flow passage, of the build object includes:
supplying the polishing fluid to the flow passage between the build object and the flow passage forming part through piping from a storing part for storing the polishing fluid, and
collecting the polishing fluid, which has flowed in the flow passage, to a collection part.

20. The build method according to claim 19, wherein
a supplying part for leading the polishing fluid, which has flowed in the piping, to the flow passage is disposed between the piping and the flow passage between the build object and the flow passage forming part.

21. The build method according to claim 19 including: returning the polishing fluid, which has flowed in the flow passage, to the storing part through a predetermined filter.

22. A build system for forming a three-dimensional build object comprising:
a build apparatus building a build object and a flow passage forming part by additive manufacturing; and
a fluid polishing apparatus performing fluid polishing a portion, which faces a flow passage between the build object and the flow passage forming part, of the build object by passing polishing fluid through the flow passage along an extending direction of the flow passage.

23. The build system according to claim 22, wherein
a shape of the flow passage forming part imitates a shape of a portion, which faces the flow passage forming part, of the build object.

24. The build system according to claim 22, wherein
the build apparatus integrally builds the build object and the flow passage forming part by additive manufacturing.

25. The build system according to claim 22, wherein
the fluid polishing apparatus has:
a storing part for storing the polishing fluid,
piping for connecting the storing part to the flow passage,
a pump part for sending the polishing fluid to the flow passage through the piping, and
a collection part for collecting the polishing fluid, which has flowed in the flow passage.

26. The build system according to claim 22 comprising:
a removing apparatus removing the flow passage forming part from the build object.
